(19) United States
(12) Patent Application Publication
(10) Pub. No.: US 2012/0320191 A1
(43) Pub. Date: Dec. 20, 2012

(54) Device for Analyzing Hair Fibers and Methods of Using the Device

(76) Inventors: Stephan James Andreas MESCHKAT, Bad Soden (DE); Faiz Fiesal Sherman, Mason, OH (US); Vladimir Gartstein, Mason, OH (US)

(21) Appl. No.: 13/517,783

(22) Filed: Jun. 14, 2012

Related U.S. Application Data
(60) Provisional application No. 61/497,383, filed on Jun. 15, 2011.

(51) Int. Cl. H04N 7/18

(52) U.S. Cl. 348/135; 348/E07.085

(57) ABSTRACT

A method and device for analyzing hair fibers comprising positioning the hair fibers on an image sensor of the device wherein the image sensor receives light from a light source, transmitting light from the light source through the hair fibers to create an image of the hair fibers on the image sensor, evaluating the image of the hair fibers using a processor resulting in processor generated analysis values, and correlating the processor generated analysis values to hair property descriptors.

### CROSS REFERENCE TO RELATED APPLICATION

This application claims the benefit of U.S. Provisional Application Ser. No. 61/497,383 filed Jun. 15, 2011.

### FIELD OF THE INVENTION

The invention relates to a device for analyzing hair fibers, and more specifically, to a device comprising an image sensor to receive the hair fibers and a light source that is positioned so as to shine light through the hair fibers to create an image of the hair fibers on the image sensor surface. An image of the hair fibers is then evaluated using a processor to get processor generated analysis values in order to determine hair property descriptors.

### BACKGROUND OF THE INVENTION

Hair fibers can be analyzed in order to serve as a parameter for hair damage level. By analyzing hair fibers, products can be created and disseminated to consumers that directly targets and mitigates the specific hair damage done to consumer's hair.

A device for measuring hair damage traditionally involves scanning electron microscopy (SEM). Using SEM, the cuticle of the hair fiber is visualized to serve as a parameter of the damage level to the hair; lifted cuticles signify a rough hair surface whereas flat and dense cuticles indicate undamaged, healthy hair. However, devices using SEM are not cost effective, and this method also results in destruction of the hair sample.

Another way to analyze hair fibers involves devices that use light reflection to measure the damage done to the hair. Damaged hair is denser than healthy hair, so by shining a light onto the hair fiber and measuring the angles of reflection, it is possible to determine the damage level of the hair. However, these devices require the hair to be separated from the consumer for analysis, and hair fibers can only be analyzed one at a time. In addition, light reflection lacks the microscopic details available to SEM.

Accordingly there is a need for a cost effective device that uses light to analyze hair damage. Furthermore, there is a need for a device that analyzes multiple hair fibers at once while keeping the hair attached to the consumer and not damaging the sample, and is able to sample large areas of the hair quickly. In addition, there is a need for a device that is portable and cost effective so as to be able to use the device during consumer consultations to recommend specific products during the point of sale.

### SUMMARY OF THE INVENTION

According to one embodiment, a method for analyzing hair fibers comprising: (a) positioning the hair fibers on an image sensor wherein the image sensor is capable of receiving light from a light source; then (b) transmitting light from the light source through the hair fibers to create an image of the hair fibers on the image sensor; then (c) evaluating the image of the hair fibers using a processor resulting in processor-generated analysis values; and then (d) correlating said processor generated analysis values to hair property descriptors.

The method according to the previous embodiment, wherein the hair property descriptors are selected from the group consisting of hair damage, hair thickness, cuticle damage, color vibrancy, split ends, percent gray, and combinations thereof. The method according to any preceding embodiments, wherein the processor generated analysis values are hair brightness and hair diameter. The method according to any preceding embodiments, wherein the image sensor has a transparent cover on the side facing the light source. The method according to any preceding embodiments, wherein the transparent cover has a thickness of from 100 microns to 600 microns.

The method according to any preceding embodiments, wherein the hair fibers are positioned on the transparent cover of the image sensor by a pin, preferably wherein the pin is positioned flat on the image sensor in order to hold the hair fibers onto the image sensor, more preferably wherein the pin comprises ridges which prevent the hair fibers from slipping off of the image sensor when the device is being moved along the hair fibers, even more preferably wherein the pin is used to spread the fibers out so that there is space between each individual fiber. The method according to any preceding embodiments, wherein the hair fibers form a single layer on the image sensor, and wherein the hair fibers have a distance between them.

The method according to any preceding embodiments, wherein the image sensor is from 0.1 to 3 inches, or from about 0.3 to about 1 inch, away from the light source. The method according to any preceding embodiments, wherein the light is transmitted from multiple light sources, preferably wherein multiple light sources with different wavelengths are used. The method according to any preceding embodiments, wherein the light source is infrared light, preferably wherein the infrared light has a wavelength from about 700 nanometers to about 1000 nanometers, or from about 800 nanometers to about 900 nanometers.

The method according to any preceding embodiments, wherein the light source is covered by a faceplate and wherein the faceplate has an aperture, preferably wherein the aperture has a diameter of 300 micrometers to 800 micrometers. The method according to the preceding embodiment, wherein the aperture has a distance from 0.2 inches to 2.0 inches away from the image sensor, and wherein the aperture has a diameter from 500 micrometers to 1200 micrometers, or from about 500 micrometers to 1200 micrometers, or from about 300 micrometers to about 900 micrometers. The method according to any preceding embodiments, wherein the image sensor is a Complementary-Metal-Oxide-Semiconductor (CMOS) imaging chip. The method according to any preceding embodiments, wherein the device comprises an upper housing and lower housing which forms the outer boundaries of the device.

The method according to any preceding embodiments, wherein the device is run down the length of the hair fibers and a push button is used to transmit light from a light source through the hair fibers at the desired place on the fibers, and wherein the transmitted light creates an image on the image sensor; and wherein the image of the hair fibers is then evaluated by a processor located either within the device or external to the device, and wherein the processor evaluates the hair fibers using processor generated analysis values which correlate to hair property descriptors.

According to another embodiment, a method of using a device for analyzing hair fibers comprising: (a) placing the hair fibers inside of the device to be analyzed, wherein the device comprises: (i) an image sensor to receive the hair fibers and wherein the image sensor is positioned so that light from a light source is transmitted through the hair fibers to create an image of the hair fibers on the image sensor; then (b) evaluating the image of the hair fibers by using a processor resulting in processor generated analysis values; and then (c) correlating said processor generated analysis values to hair property descriptors.

The method according to the previous embodiment, wherein the device is handheld and portable. The method according to any preceding embodiments, wherein the device is used to generate hair property descriptors at a point of sale. The method according to any preceding embodiments, wherein the hair property descriptors are used to recommend hair treatment products. The method according to any preceding embodiments, wherein the processor is an external processor. The method according to any preceding embodiments, wherein the processor is a microcontroller.

### BRIEF DESCRIPTION OF THE DRAWINGS

FIG. 1A illustrates a cross sectional view of a device used to analyze hair fibers;

FIG. 1B illustrates a cross sectional view of the device illustrated in FIG. 1A, with a faceplate and transparent cover in accordance with one embodiment of the invention;

FIG. 1C illustrates an embodiment of the device using minors to transmit light;

FIG. 2 illustrates an enlarged view of hair fibers on an image sensor;

FIG. 3A illustrates a top view of the device used to analyze hair fibers;

FIG. 3B illustrates an exploded view of the device illustrated in FIG. 3A;

FIG. 4 illustrates a flow chart of one embodiment of evaluation an image using a processor;

FIG. 5 illustrates an image analysis of hair fibers;

FIG. 6A illustrates an image analysis of undamaged hair fibers;

FIG. 6B illustrates an image analysis of medium damaged hair fibers; and

FIG. 6C illustrates an image analysis of damaged hair fibers.

### DETAILED DESCRIPTION OF THE INVENTION

While the specification concludes with claims which particularly point out and distinctly claim the invention, it is believed the invention will be better understood from the following definitions:

As used herein, “hair property descriptors” refers to hair damage, hair diameter, cuticle damage, color vibrancy, split ends, percent gray, and combinations thereof.

As used herein, “processor generated analysis values” refers to values for determining hair brightness and hair diameter.

As used herein, “point of sale” refers to the time when a consumer or professional is deciding on what product to purchase based on their hair care needs or their business needs.

As used herein, “transparent” refers to a property of a material to transmit light without scattering so that the light that passes through the material may still be capable of forming an image. The degree of transparency may be a characteristic of how much light can penetrate through a material but it may not change the physical process which follows the law of refraction.

As used herein, the articles including “a” and “an” when used in a claim, are understood to mean one or more of what is claimed or described.

As used herein, the terms “include,” “includes,” and “including,” are meant to be non-limiting.

The test methods disclosed in the Test Methods Section of the application should be used to determine the respective values of the parameters of Applicants' inventions.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### The Device

The system for analyzing hair fibers comprises a device with a light source and an image sensor, where the light source shines through the hair fibers placed on the image sensor and creates an image of the hair fibers on the image sensor. The image of the hair fibers is then evaluated using processor generated analysis values which correlate to hair property descriptors. Each of these essential components, as well as optional components, are described in detail hereinafter.

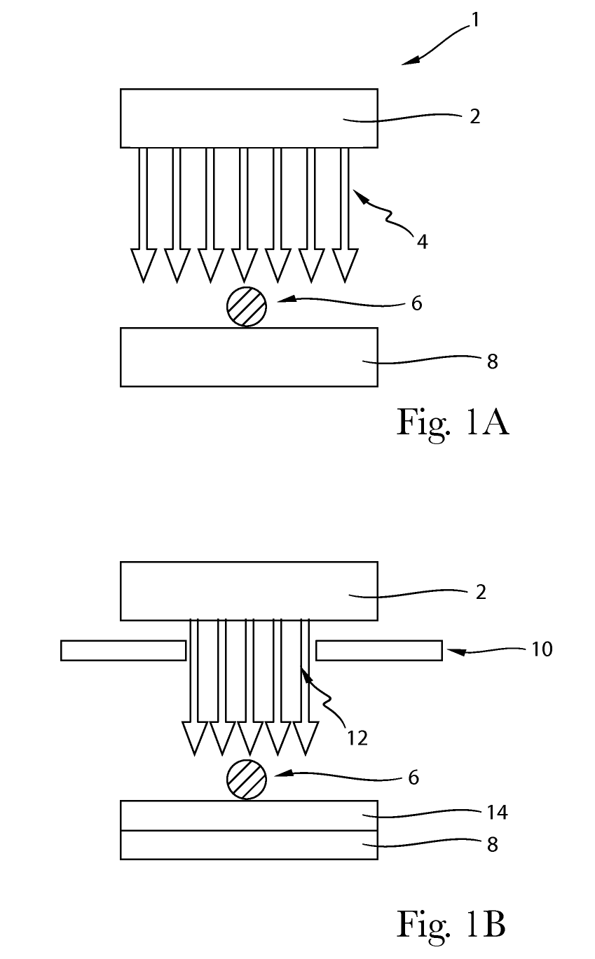

Referring now to the Figures, and to FIGS. 1A and 1B in particular, a device is shown in accordance with the principles of the invention. The device will be described herein in connection with analyzing hair fibers. The device is readily adaptable to analyzing hair property descriptors associated with the hair fibers. Non-limiting examples of such hair property descriptors include hair damage, hair thickness, cuticle damage, color vibrancy, split ends, percent gray, and combinations thereof.

The device for analyzing hair fibers operates under the principle that hair is transparent to light. In one embodiment, the light is infrared light. Hair fibers are composed of an internal region called the cortex and an outer region called the cuticula. The cuticula for undamaged hair is smooth regardless of the natural color of the hair, but as damage to hair fibers increases, so does the roughness of the cuticula (i.e. through styling, coloring, etc.). Depending on the hair fiber's surface constitution, the light from the device is refracted differently. By placing a light source opposite to an image sensor, hair fibers placed in between will create an image on the image sensor. By analyzing this image using processor generated analysis values, information on the hair constitution can be determined. Analysis of the light refraction is the same regardless of the color of the hair.

As shown in FIG. 1A, the device 1 incorporates a light source 2 and an image sensor 8 with the image sensor being positioned so that hair fibers 6 on the image sensor are able to receive light 4 from the light source 2. In an embodiment, the light source 2 is positioned from about 0.1 inches to about 3 inches [from about 0.25 cm to about 7.3 cm] away from the image sensor 8, or from about 0.2 to about 2 inches [from about 0.51 cm to about 5.1 cm] away from the image sensor, or from about 0.3 to about 1 inch [from about 0.76 cm to about 2.54 cm] away from the image sensor. It will be appreciated by those of ordinary skill in the art that other configurations of the image sensor and the light source are possible besides the parallel configuration shown in FIG. 1A and FIG. 1B, so long as the image sensor is able to receive light from the light source. In one embodiment, the light source may be further away and light is brought to the fibers by a light pipe. In another embodiment, illustrated by FIG. 1C, the light source 2 is not in a position that is directly opposite the image sensor 8, and the light 4 is therefore guided by minors 7 from the light source to the image sensor.

In accordance with the embodiment, a light source shines light onto the image sensor in order to create an image. In one embodiment, multiple light sources with the same wavelength may be used to shine light onto the image sensor in order to create an image. In another embodiment, multiple light sources with different wavelengths may be used.

In one embodiment, light from the light source is infrared light. In one example, an IR-LED is used as the light source to generate infrared light. In an embodiment, the infrared light has a wavelength from about 700 nanometers to about 1000 nanometers, or from about 800 nanometers to about 900 nanometers.

As seen in FIG. 1B, the light source 2 may be covered by a faceplate 10 having an aperture 12. The faceplate 10 functions to eliminate stray light and to generate sufficiently collimated light. The aperture 12 may be placed anywhere on the faceplate as long as the light is able to pass through. In one embodiment, the aperture is placed right on the light source and close to the hair fibers. In another embodiment, the aperture is further away from the light source and close to the hair fibers. In another embodiment, the aperture is from about 0.2 inches to about 2.0 inches [from about 0.51 cm to about 5.1 cm] away from the light source. In an embodiment, the aperture has a diameter from about 300 micrometers to about 1200 micrometers, or from about 500 micrometers to 1200 micrometers, or from about 300 micrometers to about 900 micrometers.

Further referring to FIG. 1B, the device has an image sensor on which hair fibers 6 are placed in order to generate an image of the hair fibers on the image sensor. In one embodiment, the image sensor is a Complementary-Metal-Oxide-Semiconductor (CMOS) imaging chip. The image sensor may optionally comprise a transparent cover 14 on the side of the image sensor facing the light source. The transparent cover can be composed of plastic, glass, or combinations thereof. The transparent cover is used to achieve the correct focal distance from the light source to the image sensor. In one embodiment, the transparent cover has a thickness of from about 100 microns to about 600 microns.

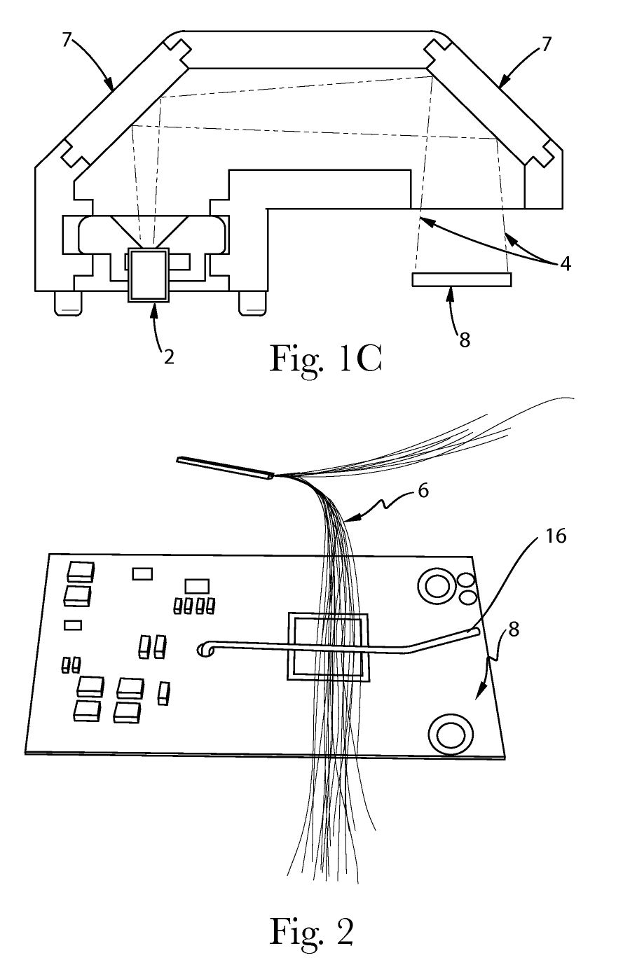

As seen in FIG. 2, a pin 16 may be positioned flat on the image sensor 8 in order to hold the hair fibers 6 onto the image sensor. In one embodiment, the pin 16 is spring loaded so that it can automatically adjust to accommodate different hair thicknesses. The pin may be comprised of materials such as metal, plastic, and combinations thereof. In one embodiment, the pin is made of steel. When the hair fibers are moved along the hair's longitudinal axis they are flattened out under the force of the pin, creating a single layer of multiple hair fibers. In one embodiment, the pin comprises ridges which prevent the hair fibers from slipping off of the image sensor when the device is being moved along the hair fibers. In one embodiment, the pin is used to spread the fibers out so that there is space between each individual fiber.

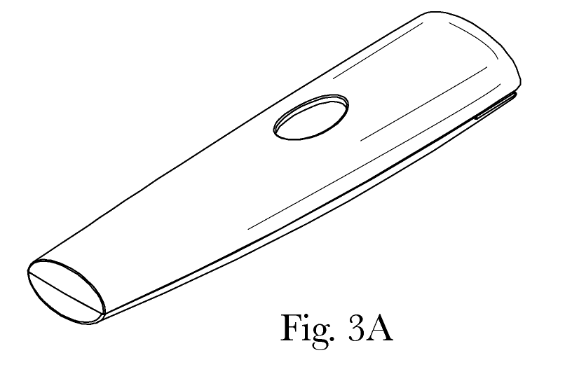

FIG. 3A shows a top view of the device for analyzing hair fibers while FIG. 3B illustrates an exploded view of the device shown in FIG. 3A. Referring to FIG. 3B, in one embodiment the device comprises an upper housing 18 and lower housing 20 which forms the outer boundaries of the device. In one embodiment, the upper and lower housing is made of plastic. The hair is inserted into the device in between the upper and lower housings, and is placed onto the main board 22 which holds the image sensor 8. The hair fibers can then be secured onto the image sensor 8 by the pin 16 located in a pin holder 24. The hair fibers can be placed on the image sensor at the root of the fibers, the tip of the fibers, or in the middle of the fibers. In one embodiment, the device is run down the length of the hair fibers and a push button 26 is used to transmit light from a light source 2 through the hair fibers at the desired place on the fibers. This transmitted light creates an image on the image sensor. The image of the hair fibers is then evaluated by a processor located either within the device or external to the device. This processor evaluates the hair fibers using processor generated analysis values which correlate to hair property descriptors.

The device is configured to be handheld and portable, and has a battery tray 28 in which batteries 30 can be by inserted. In another embodiment, the device is configured to be plugged in. The portable nature of the device allows it to be placed along several manually selected bunches of hair down the entire length of the hair. In one embodiment, the hair fibers can be placed in the device while still attached to the consumer.

### Evaluating the Hair Fibers

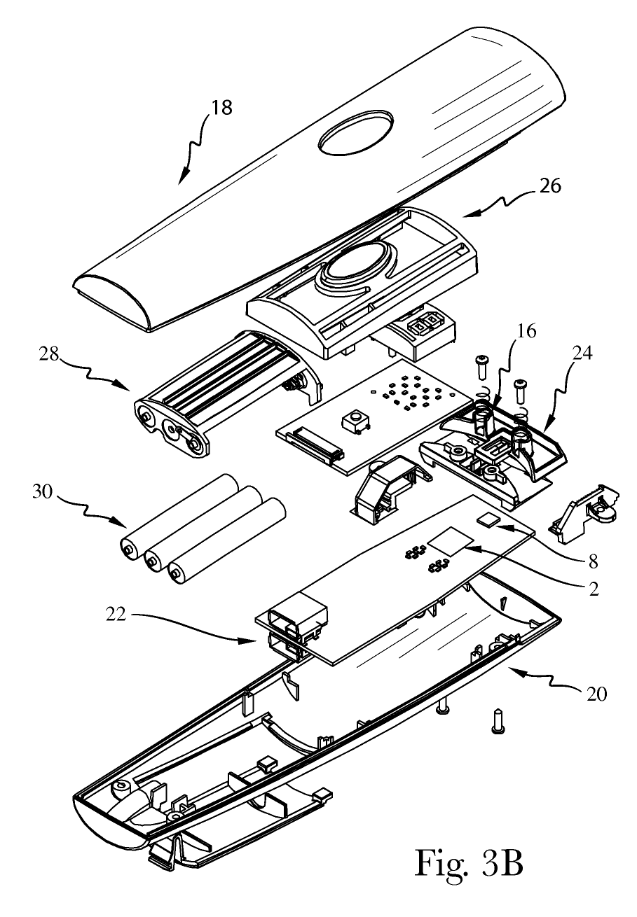

The hair fibers are then evaluated by a processor which may be either an external processor connected to the device or an internal processor which is part of the device. FIG. 4 illustrates one embodiment in which an external processor 32 is connected to the device and transmits images from the image sensor 8 to the processor to be evaluated. The external processor can be a PC, tablet, or mobile phone. In one embodiment, the external processor can be connected wirelessly to the device.

The processor may also be an internal processor that is part of the device. In one embodiment, the internal processor is a microcontroller within the device. The processor generated analysis values are evaluated within the internal processor, and subsequently shown on a display screen located on the device.

For either embodiment, the processor evaluates a hair fiber image taken for each hair fiber placement. The processor evaluates the hair fibers to get processor generated analysis values for hair brightness and hair diameter.

### Hair Brightness Values

In determining hair brightness values, the processor takes an average value of the combined image sensor pixel brightness values from areas where the presence of hair is identified.

The presence of hair is identified in three steps. In the first step, the pixel values for the entire image are shifted stepwise by one pixel. This shifting continues until 30 microns worth of movement in the longitudinal direction of the hair orientation is reached. After each shifting movement, the brightness value of each pixel is taken and then compared to its value before the image had been moved. The lowest brightness value is recorded for each pixel. The same shifting motion is then repeated in a longitudinal direction opposite the direction taken before, beginning with the lowest value of the recorded shifts. The lowest brightness values are recorded for each pixel. The lowest pixel values for both directions are then used to overwrite pixel values from the initial image which were in the range of plus or minus 30 microns in the longitudinal direction of the hair fibers. This substitution creates a low-pass filter which functions to remove all elements of increased brightness being smaller than 60 microns in the longitudinal direction of the hair fibers.

In the second step, pixels with brightness values which are lower than the pixel brightness values for the areas where no hair is present are defined. These areas are defined as being areas where hair is present. In the third step, an over-all results value for brightness is determined by taking the average of the values from where hair is present in the original image.

In another embodiment, the results value calculated in step three is obtained by using an algorithm which looks at the frequency scale of brighter and darker areas inside of the identified hair areas. In yet another embodiment, the results value calculated in step three is obtained by using an algorithm which looks at the ratio between brighter and darker areas in the hair fibers.

### Hair Diameter Values

Hair diameter values are determined based on the counting of pixels and the creation of a width array based on the hair brightness image described above. As described in detail above, the hair brightness values are taken where hair is present and where areas of brightness less than 60 microns have been removed from the image. The counting of the pixels for determining hair diameter starts at the first row of the image. This means that the counting of the pixels begins from one edge of the image and progresses along the longitudinal direction of the hair fibers. Pixels with low brightness values are counted while moving pixel by pixel along the row. This continues until a pixel with a high brightness value is found, in which case the counting of the pixels stops.

At this stopping point, if the number of counted pixels with low brightness values covers 40 microns or more, or 150 microns or less, than the number of counted pixels is kept as a hair width-value. This hair width value is subsequently placed in a hair width number array at a position closest to the center of the pixels with low brightness values. A nonlimiting example shows that if the pixel size is 3 microns, and counted pixels 71 to 100 (while starting to count from 1 at the beginning of the row) are showing low brightness values, then the hair width-value is 30 and is kept at position 86. This is based on all other hair width-values being set to zero initially.

This width-array for determining hair diameter is preserved while the same procedure is repeated for the next row. After the pixels have been counted in this row, their current values and their current positions are compared to the values and positions of row one. For each row value that has not moved more than two positions in either direction, the current row value is added to the previous row value and stored at the current position. At the same time, all previously determined values for the two positions in either direction of the stored value are set back to zero.

This resetting creates a new hair width-array that is then compared to the next row and then so on. Each time a width-value is added to the array, an additional length-counter is increased by 1 and stored in an additional length-array at the same position as in the width-array. When the length-counter is not able to be increased due to the fact that no valid width-value is about to be determined, the current length-counter is checked. This length checking involves determining if the hair length is longer than 200 microns. If the hair length is longer than 200 microns, then the corresponding values in the width array and the length array are preserved. If the hair length is less than 200 microns, then the corresponding width and length array values are set to zero.

This process continues until the last row in the image is reached. When this occurs, each value in the hair width-array is divided by the corresponding value in the length array to get average width values. Subsequently multiplying these average width-values with their individual pixel-sizes gives the final hair diameter values.

The lowest diameter value is determined to be the diameter of a single hair. This determination is performed in order to take into account the natural variation individual's have in hair diameter. In addition, this single hair diameter determination helps to prevent a false diameter read which can occur when two or three overlapping hairs appear as a single hair. Comparing these single hair diameter results with lab-measurements of different hair diameters ensures adequacy of measurements.

The device is well suited to analyze hair diameters ranging from about 40 to about 150 microns with a resolution of 2-3 microns, depending on the resolution of the image sensor.

### Determining Hair Property Descriptors

The processor generated analysis values of hair brightness and hair diameter are then correlated to corresponding hair property descriptors. A non-limiting list of hair property descriptors includes hair damage, hair thickness, cuticle damage, color vibrancy, split ends, percent gray, and combinations thereof. Since each of these descriptors is indirectly or directly related to the refraction of light through a hair fiber, the device is able to provide an accurate and reliable indication of the level of damage of the hair fiber.

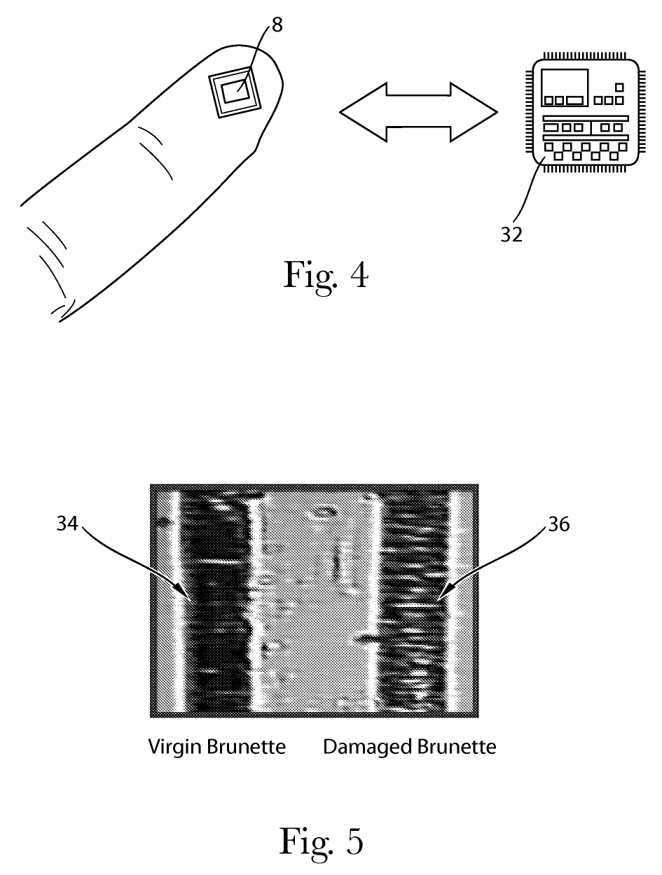

Hair brightness values correlate to the hair property descriptors of: hair damage, cuticle damage, color vibrancy, and percent gray. These hair property descriptors all share the common characteristics of either lifted cuticles or cuticle loss. FIG. 5 shows an image analysis of what the cuticle looks like for virgin hair 34 compared to damaged hair 36. The fringe areas on the damaged hair illustrate cuticle damage. When the cuticles are either lifted and/or removed, the resulting surface of the hair fibers becomes rough. Hair brightness values are relevant to these hair property descriptors since this roughness causes light to be refracted into the hair image. This refracted light causes an increase in brightness within the hair image's shadowy areas. This refraction of light is dependent on cuticle roughness, but is independent of hair color. Therefore, a brunette individual and a blond individual with the same level of cuticle roughness would show an identical image analysis.

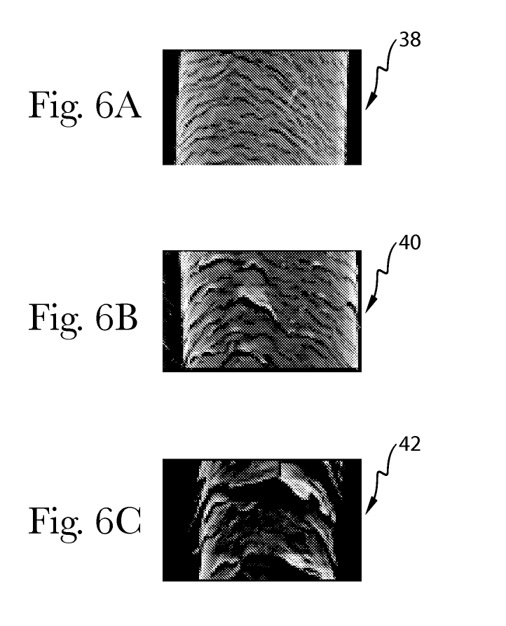

FIGS. 6A-6C further illustrates the presence of lifted cuticles when evaluating hair damage. FIG. 6A shows an image analysis of undamaged hair 38 in which the cuticles lie flat. FIG. 6B shows an image analysis of medium damaged hair 40 in which the cuticles are slightly raised. FIG. 6C shows an image analysis of damaged hair 42 in which cuticles are prominently raised on the hair fibers.

Results show that brightness values of about 60 to about 120 correlates to virgin hair, brightness values of about 121 to about 180 correlates to medium damaged hair, and brightness values of about 181 to about 210 or higher correlates to damaged hair. This determination about the state of the hair allows for the recommendation of hair treatment products based on the individual's hair.

In addition, hair diameter values can be correlated to the hair property descriptor of hair thickness. If the hair diameter of a single fiber, determined by the methods described above, falls within about 40 to about 65 microns than the individual has thick hair, if the diameter is from about 66 to about 85 microns then the individual has medium hair, and if the diameter is from about 85 microns to about 200 microns then the individual has thin hair. This determination of thickness can then be used for the recommendation of hair treatment products based on the individual's personal hair type needs.

### Method of Use

Because the device has the characteristics disclosed herein, it can be used at the point of sale during a consumer consultancy in order to provide the consumer with these hair property descriptors. In combination with an electronic questionnaire, the hair property descriptors are then used to recommend hair treatment products to modify the consumer's hair properties. In addition, the device can also be used by professionals. Furthermore, the device can be used as an in-home diagnostic tool.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for analyzing hair fibers comprising:
a. positioning the hair fibers on an image sensor wherein the image sensor is capable of receiving light from a light source;
b. transmitting light from the light source through the hair fibers to create an image of the hair fibers on the image sensor;
c. evaluating the image of the hair fibers using a processor resulting in processor-generated analysis values; and
d. correlating said processor generated analysis values to hair property descriptors.

2. The method according to claim 1, wherein the hair property descriptors are selected from the group consisting of hair damage, hair thickness, cuticle damage, color vibrancy, split ends, percent gray, and combinations thereof.

3. The method according to claim 1, wherein the processor generated analysis values are hair brightness and hair diameter.

4. The method according to claim 1, wherein the image sensor has a transparent cover on the side facing the light source.

5. The method according to claim 1, wherein the transparent cover has a thickness of from about 100 microns to about 600 microns.

6. The method according to claim 1, wherein the hair fibers are positioned on the transparent cover of the image sensor by a pin.

7. The method according to claim 1, wherein the hair fibers form a single layer on the image sensor, and wherein the hair fibers have a distance between them.

8. The method according to claim 1, wherein the image sensor is from about 0.1 to about 3 inches away from the light source.

9. The method according to claim 1, wherein the light is transmitted from multiple light sources.

10. The method according to claim 1, wherein the light source is infrared light

11. The method according to claim 1, wherein the light source is covered by a faceplate and wherein the faceplate has an aperture.

12. The method according to claim 11, wherein the aperture has a diameter of about 300 micrometers to about 800 micrometers.

13. The method according to claim 11, wherein the aperture has a distance from about 0.2 inch to about 2.0 inch away from the image sensor, and wherein the aperture has a diameter from about 500 micrometers to about 1200 micrometers.

14. The method according to claim 1, wherein the image sensor is a Complementary-Metal-Oxide-Semiconductor (CMOS) imaging chip.

15. A method of using a device for analyzing hair fibers comprising:
a. placing the hair fibers inside of the device to be analyzed, wherein the device includes:
i. an image sensor to receive the hair fibers and wherein the image sensor is positioned so that light from a light source is transmitted through the hair fibers to create an image of the hair fibers on the image sensor;
b. evaluating the image of the hair fibers by using a processor resulting in processor-generated analysis values; and
c. correlating said processor-generated analysis values to hair property descriptors.

16. The method according to claim 15, wherein the device is handheld and portable.

17. The method according to claim 15, wherein the device is used to generate hair property descriptors at a point of sale.

18. The method according to claim 15, wherein the hair property descriptors are used to recommend hair treatment products.

19. The method according to claim 15, wherein the processor is an external processor.

20. The method according to claim 15, wherein the processor is a microcontroller.
